(19) United States
(12) Patent Application Publication
(10) Pub. No.: US 2008/0069135 A1
(43) Pub. Date: Mar. 20, 2008

(54) Discreet control of data network resiliency

(75) Inventors: Robert G. Forrest, Pflugerville, TX (US); David C. Kooistra, Rochester, MN (US)

Correspondence Address: CANTOR COLBURN LLP - IBM ROCHESTER DIVISION, 20 Church Street, 22nd Floor, Hartford, CT, 06103, US

(73) Assignee: International Business Machines Corporation, Armonk, NY (US)

(21) Appl. No.: 11/532,937

(22) Filed: Sep. 19, 2006

(51) Int. Cl. H04J 3/22

(52) U.S. Cl. 370/465

(57) ABSTRACT

A method and system for discreetly controlling data network resiliency including: a plurality of networks, each of the plurality of networks connected to each other via a primary connection and a secondary connection; a source location for transmitting one or more packets; a destination location for receiving the one or more packets; and a plurality of nodes connecting the source location and the destination location to one or more of the plurality of networks; wherein the one or more packets travel from the source location to the destination location via the plurality of networks; and wherein each of the one or more packets includes a resilient bit in a header portion, the resilient bit designating a bit status for allowing each of the plurality of nodes to determine whether the one or more packets travel on the secondary connection in order to reduce the bandwidth of the secondary connection.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data networks, and particularly to resiliency of packets traveling within Wide Area Networks (WANs). Local Area Networks (LANs) or Metropolitan Area Networks (MANs) typically aren't as costly to provide resiliency however this invention is applicable to these environments also.

2. Description of Background

Wide Area Network (WAN) resiliency (backup connections) decisions are typically made at a site (location) level while the processes that require resiliency are often a very small subset of the processes that are performed in a location. Backup WAN connections are very expensive insurance given that in a perfect world they are seldom used. If resiliency could be managed at a port or application level the backup bandwidth could be substantially reduced at significant cost savings.

Other approaches to solving this sub-setting of resiliency requirement involve building separate physical or logical VLANs (Virtual Local Area Networks) which, however, introduce additional complexity and cost into the network, thus reducing or eliminating the savings of reducing the backup bandwidth requirements.

Considering the limitations of the aforementioned methods, it is clear that there is a need for an efficient method for discreetly controlling data network resiliency as opposed to a site level control.

### SUMMARY OF THE INVENTION

The shortcomings of the prior art are overcome and additional advantages are provided through the provision of a system for discreetly controlling data network resiliency, the system comprising: a plurality of networks, each of the plurality of networks connected to each other via a primary connection and a secondary connection; a source location for transmitting one or more packets; a destination location for receiving the one or more packets; and a plurality of nodes connecting the source location and the destination location to one or more of the plurality of networks; wherein the one or more packets travel from the source location to the destination location via the plurality of networks; and wherein each of the one or more packets includes a resilient bit in a header portion, the resilient bit designating a bit status, the bit status allowing each of the plurality of nodes to determine whether the one or more packets travel on the secondary connection in order to reduce the bandwidth of the secondary connection.

The shortcomings of the prior art are overcome and additional advantages are provided through the provision of a method for implementing data network resiliency, the method comprising: receiving a data packet at a decision node included within one or more data networks, the data packet including a resilience bit indicative of whether the data packet is to be transmitted through the data networks from a source location to a destination location regardless of whether a failure exists in a primary network path; implementing a decision subroutine, further comprising: determining whether the data packet has reached the destination location and delivering the data packet in the event the data packet has reached the destination location; determining, in the event the data packet has not yet reached the destination location, whether the primary network path has been broken, and forwarding the data packet onward in the event the primary network path has not been broken; determining, in the event the primary network path has been broken, whether the resilience bit is active, and discarding the data packet in the event the resilience bit is inactive; otherwise, in the event the resilience bit is active, forwarding the data packet along a secondary network path; and repeating the decision subroutine until the data packet is either discarded or delivered to the destination location.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for an efficient system and method for discreetly controlling data network resiliency.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a WAN system having a primary connection and a backup connection according to the exemplary embodiments of the present invention;

FIG. 2 illustrates one example of a flowchart describing packet flow with no resilience to protect the network from a failed path;

FIG. 3 illustrates one example of a flowchart describing packet flow will full resilience to protect the network from a failed path; and

FIG. 4 illustrates one example of a flowchart describing packet flow with specified resilience to protect the network from a failed path according to the exemplary embodiments of the present invention.

### DETAILED DESCRIPTION OF THE INVENTION

One aspect of the exemplary embodiments is a method for discreetly controlling data network resiliency. The exemplary embodiments of the present invention enable a packet coming into a network from a device to contain a bit that indicates that the packet is to flow through the network, even in a backup environment. Specifically, one or more packets flow through the network until the one or more packets reach a point or a node where there is a backup decision to be made. If the network is running on a primary connection, the packet flows on to the next decision point. However, if a backup connection is in use, packets without the “backup bit” are dropped and only packets with the “backup bit” continue to flow. Thus, the net is that the backup bandwidth can be sized differently (likely smaller) from the primary bandwidth, resulting in a cost savings. Therefore, only “important” traffic gets the backup bit turned on and flows in a backup connection environment.

The primary connection is the network link that a packet would travel on normally. A backup connection is the network link that a packet would travel on when the primary connection has failed. These two links can be on the same network (same provider and/or same technology) or different networks (e.g., backup via Internet VPN (Virtual Private Network)).

If equal performance is desired while running on the backup connection, the backup connection is required to have equal capacity and performance characteristics (latency, packet drop, etc.) as the primary connection. In a typical network the primary connection is available 99% of the time, thus forcing a user to pay a significant sum of money for a backup connection that is very seldom used. Therefore, a backup environment is an environment where the primary connection has failed (e.g., fiber cut, hardware failure, etc.) and the traffic flows on the backup connection.

In the exemplary embodiments, the capacity of the backup connection capacity is based upon the need to backup only business critical applications, thus the cost of the backup connection that is used (10% or less in most situations) is significantly less than the cost of the primary connection.

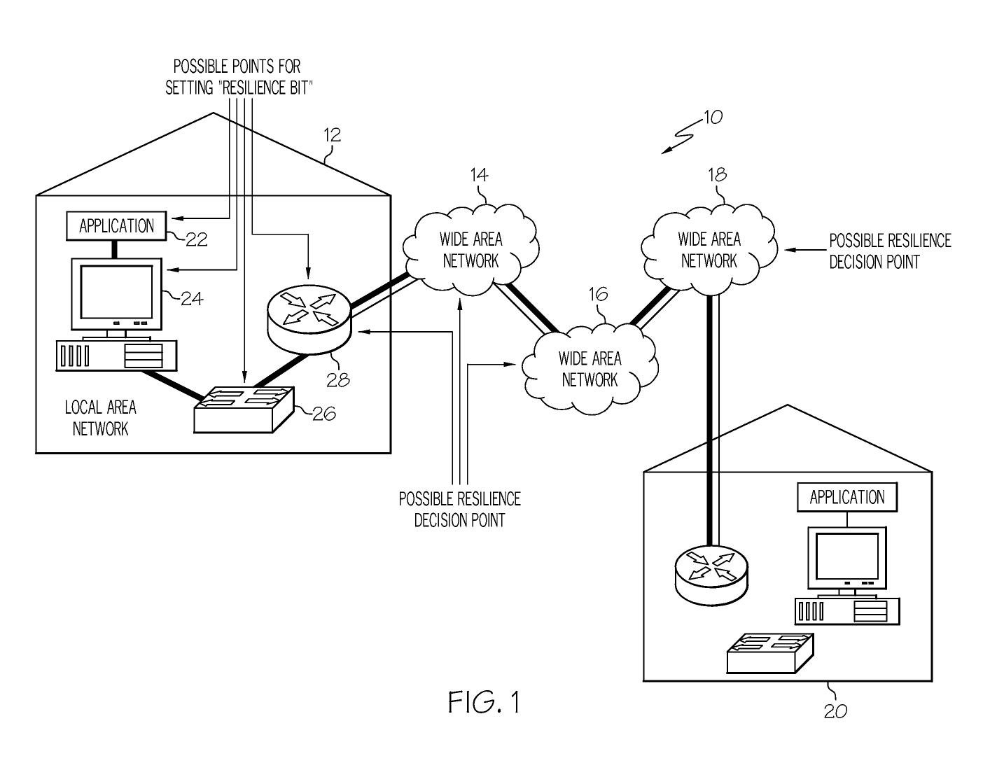

FIG. 1 illustrates one example of a block diagram of a WAN system having a primary connection and a backup connection according to the exemplary embodiments. The WAN system 10 includes a first location 12, WANs 14, 16, 18, and a second location 20. The first location 12 may be a transmitting station (source), such as a home. The first location 12 includes an application 22, a workstation 24, connecting means 26, and a decision node 28. The second location 20 may be a receiving location (destination), such as another home. The second location 20 may also include similar elements as the first location 12 (e.g., an application, a workstation, a connecting means, and a decision node).

In the WAN system 10, a “full” WAN connection (wide line) between entities and a “narrow” WAN connection (narrow line) to serve as backup connection are illustrated. Therefore, the full WAN connection links all the intermediate WANs with the first location 12 and the second location 20, as well as the components within the first location 12 and the second location 20. The narrow WAN connection links the intermediate WANs with the first location 12 and the second location 20. However, the components within the first location 12 and the second location 20 are not connected via the narrow WAN. In the WAN system 10, a packet of data may be sent from the first location 12 via the WANs 14, 16, 18 to the second location 20. Every packet sent between the first location 12 and the second location 20 includes a resilience bit. At every point where there is a smaller or narrower backup path the resilience bit of the packet is leveraged to determine if the packet should be forwarded or dropped if the primary path has failed. The decision to keep or drop a packet is made by decision nodes. If the packet includes an active (“ON”) resiliency bit, then the packet continues to flow through the backup connection. However, if the packet includes an inactive (“OFF”) resiliency bit, then the packet is rejected and does not flow through the backup connection.

By employing this decision method, the exemplary embodiments of the present invention allow the traffic (plurality of packets) that a business determines critical to its operation to be provided with resilience. As a result, the backup capacity can be substantially smaller than the primary capacity at a significant cost savings. For instance, a site may have DS3 (45 Mbps) primary capacity but only T1 (1.5 Mpbs) backup capacity. In the U.S. typical pricing for a T1 is between ⅕^{th} and 1/10^{th} that of a DS3.

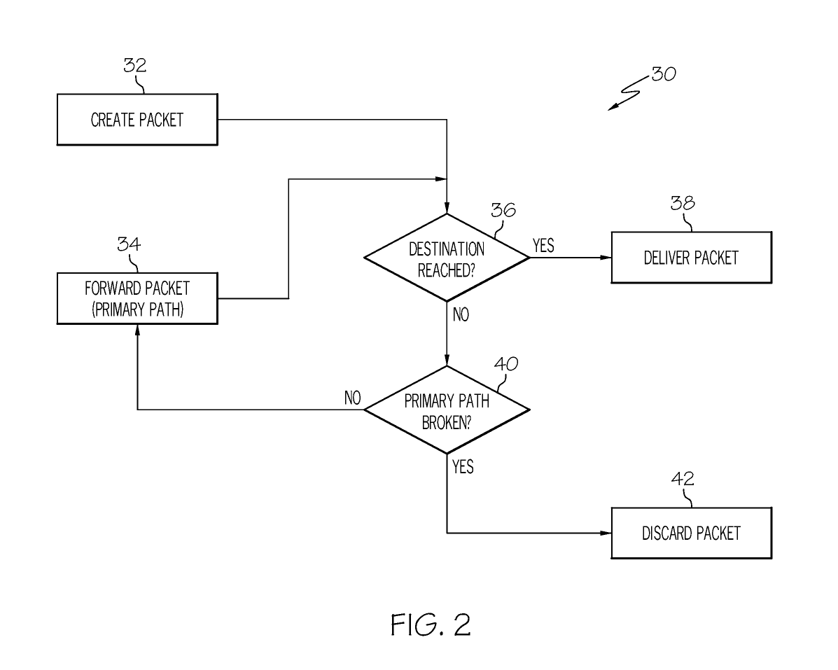

FIG. 2 illustrates one example of a flowchart describing packet flow with no resilience to protect the network from a failed path. The flowchart 30 illustrates when a packet is delivered by a node or is rejected by a node within a system of WANs. In step 32, a packet is created. In step 34, the packet is forwarded to another location within a WAN system via a primary path. In step 36, the node determines whether the final destination of the packet has been reached. If the final destination of the packet has been reached, the system flows to step 38 where the packet is confirmed to be delivered. If the node determines that the final destination of the packet has not been reached, the system flows to step 40. In step 40, the node determines if the primary path has been broken. If so, the process flows to step 42 where it is discarded. If the primary path has not been broken, then the process flows back to step 34 where the packet continues to flow through the primary connection.

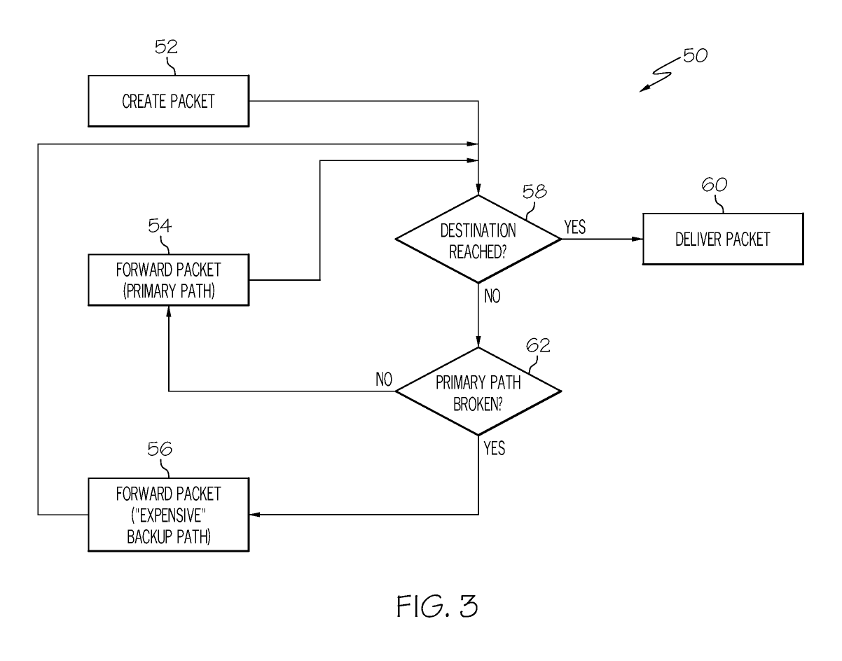

FIG. 3 illustrates one example of a flowchart describing packet flow with full resilience to protect the network from a failed path. The flowchart 50 illustrates when a packet is delivered by a node or is rejected by a node within a system of WANs according to the exemplary embodiments of the present invention. In step 52, a packet is created. In step 54, the packet is forwarded to another location within a WAN system via a primary path. In step 58, the node determines whether the final destination of the packet has been reached. If the final destination of the packet has been reached, the system flows to step 60 where the packet is confirmed to be delivered. If the node determines that the final destination of the packet has not been reached, the system flows to step 62. In step 62, the node determines if the primary path has been broken. If so, the process flows to step 56 where the packet continues to flow in the backup connection. If the primary path has not been broken, then the process flows back to step 54 where the packet continues to flow through the primary connection.

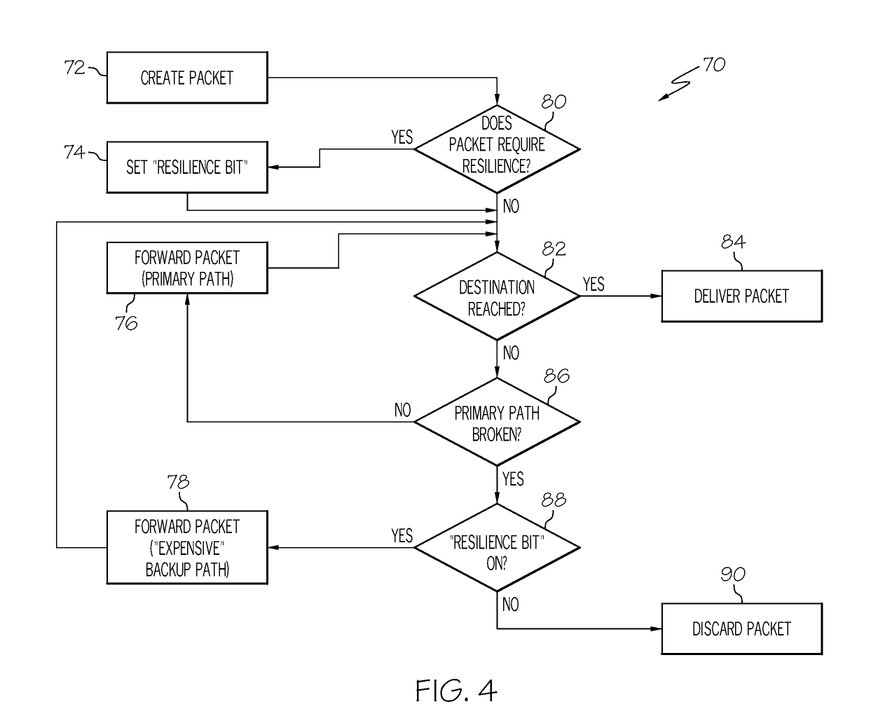

In flowchart 50 there is full back-up path and capacity. In this scenario if the primary path fails, the backup is leveraged. However, the back-up cost is still equal to the primary cost, therefore the total cost is doubled to provide resiliency. As a result, this is still an expensive option because the backup network is extensively utilized. Nevertheless, it is an option with the least amount of risk concerning lost packets or wrongfully designated packets. Thus, another less expensive option with manageable risk is described with reference to FIG. 4.

FIG. 4 illustrates one example of a flowchart describing packet flow with specified resilience to protect the network from a failed path according to the exemplary embodiments of the present invention. The flowchart 70 illustrates that when a packet is delivered by a node or is rejected by a node within a system of WANs, a less-expensive method is the result, in comparison to the system described in FIG. 3.

In step 72, a packet is created. In step 80, the node determines whether the packet requires resilience based on critical business parameters. If determined critical, in step 74, a resilience bit is set and the system flows to step 82. If the node determines that resiliency isn't needed the system flows directly to step 82. In step 82, the node determines whether the final destination of the packet has been reached. If the final destination of the packet has been reached, the system flows to step 84 where the packet is confirmed to be delivered. If the node determines that the final destination of the packet has not been reached, the system flows to step 86. In step 86, the node determines if the primary path has been broken. If not, the process flows to step 76 where the packet continues to flow in the primary connection. If the primary path has been broken, then the process flows to step 88. In step 88, it is determined whether the resilience bit is turned “ON.” In other words, has the resilience bit set to be activated or deactivated for this specific packet. If the resilience bit is deactivated or set to “OFF,” then the process flows to step 90, where the packet is discarded. If the resilience bit is “ON,” then the process flows to step 78 where the packet with the resilience bit set to “ON” is forwarded via the backup connection.

In flowchart 70, a bit is turned on in the packet to indicate its need for resiliency. In this scenario if the primary path fails and the resiliency bit has been turned on the backup connection is leveraged. This option is much more cost effective than full backup while still providing resiliency for critical business processes because it allows a user to detect less important packets and reject them via decision nodes before such packets reach the backup network.

Concerning the one or more bits inserted into a packet transmitted from a source to a destination within a WAN network, there are a set of bits in the network packet commonly referred to as the DiffServ field. Several of the bits in this field have been set as “experimental bits”. The exemplary embodiments of the present invention propose utilizing one of these experimental bits. Also, the bit would be re-designated by the appropriate standards body. The setting of this bit can take place via several services along the path. For instance, the application that generates the packet can set the bit, the operating system (Windows, Linux, etc.) can set the bit or the network devices (switches, routers) along the path can set the bit. Any or all of these services can interrogate other information to determine if they should set (or even reset) the bit.

Concerning the determination of the backup bit by the WAN system at each node of the system, most enterprise networking equipment has the ability to examine each and every packet header at the bit level (this is where the ‘resiliency bit’ would be located). This equipment also has state information about the resources it manages (i.e., primary and back-up connections, etc.). Utilizing this information the network gear can make logic decisions on what to do with the packet (e.g., drop it, forward it, change bits, etc.). In the case of Cisco routers and switches this function is implemented through ACLs (Access Control Lists).

In addition, once a node of a WAN system has dropped a packet, a user may be notified of such occurrence. Also, one or more user may be permitted to monitor how many packets each node within the WAN system has dropped. Furthermore, software may be developed to keep track of such events with one system administrator who may access such information and evaluate it. All these options depend on the network equipment vendor and to what degree each of these options could be achieved through programming interfaces, such as ACL's in Cisco's case.

As a result, the exemplary embodiments illustrate how to make the resiliency decision much more discreetly (vs. the site level) while maintaining existing network architecture. This solution gives the business maximum flexibility on what processes or which people are provided resiliency. To implement this solution at the network port, a port would be designated as resilient or not. A resilient a bit would be turned on in the network header of every packet received on resilient ports. When the traffic reaches the WAN demarcation a decision on what to do with the packet would be made. If running on primary bandwidth, both resilient and non-resilient packets would be forwarded. If running on backup bandwidth on resilient packets would be forwarded, non-resilient packets would be dropped.

The exemplary embodiments may be implemented with current technology, leveraging logical VLANs (Virtual Local Area Networks) and access control lists for setting the resilient bit (possibly one of the DiffServ bits already in every IP (Internet Protocol) header). Again, ACLs (Access Control Lists) can be leveraged at the WAN demarcation to make the decision to transport or drop the packet.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for discreetly controlling data network resiliency, the system comprising:
a plurality of networks, each of the plurality of networks connected to each other via a primary connection and a secondary connection;
a source location for transmitting one or more packets;
a destination location for receiving the one or more packets; and
a plurality of nodes connecting the source location and the destination location to one or more of the plurality of networks;
wherein the one or more packets travel from the source location to the destination location via the plurality of networks; and
wherein each of the one or more packets includes a resilient bit in a header portion, the resilient bit designating a bit status, the bit status allowing each of the plurality of nodes to determine whether the one or more packets travel on the secondary connection in order to reduce the bandwidth of the secondary connection.

2. The system of claim 1, wherein each of the plurality of nodes is a decision node.

3. The system of claim 1, wherein the source location is connected to a first network via a first decision node.

4. The system of claim 3, where the destination location is connected to a second network via a second decision node.

5. The system of claim 1, wherein the bit status is designated as “ON.”

6. The system of claim 1, wherein the bit status is designated as “OFF.”

7. The system of claim 1, wherein the resilient bit is an experimental bit located in a DiffServ field.

8. The system of claim 1, further comprising means for notifying a system administrator which of the one or more packets travel on the secondary connection after status bit determination.

9. A method for implementing data network resiliency, the method comprising:
receiving a data packet at a decision node included within one or more data networks, the data packet including a resilience bit indicative of whether the data packet is to be transmitted through the data networks from a source location to a destination location regardless of whether a failure exists in a primary network path;
implementing a decision subroutine, further comprising:
determining whether the data packet has reached the destination location and delivering the data packet in the event the data packet has reached the destination location;
determining, in the event the data packet has not yet reached the destination location, whether the primary network path has been broken, and forwarding the data packet onward in the event the primary network path has not been broken;
determining, in the event the primary network path has been broken, whether the resilience bit is active, and discarding the data packet in the event the resilience bit is inactive;
otherwise, in the event the resilience bit is active, forwarding the data packet along a secondary network path; and
repeating the decision subroutine until the data packet is either discarded or delivered to the destination location.

10. The method of claim 9, wherein the source location is connected to a first network via a first decision node.

11. The method of claim 10, where the destination location is connected to a second network via a second decision node.

12. The method of claim 9, wherein the resilience bit is designated as “ON” when active.

13. The method of claim 9, wherein the resilience bit is designated as “OFF” when inactive.

14. The method of claim 9, wherein the resilient bit is an experimental bit located in a Differv field.

15. The method of claim 9, wherein a system administrator is notified when the data packet travels on the secondary connection after resilient bit determination.

16. A method for controlling data network resiliency at a port level, the method comprising:
providing a plurality of networks, each of the plurality of networks connected to each other via a primary connection and a secondary connection;
transmitting one or more packets via a source location;
receiving the one or more packets via a destination location; and
connecting the source location and the destination location to one or more of the plurality of networks via a plurality of nodes;
wherein the one or more packets travel from the source location to the destination location via the plurality of networks; and
wherein each of the one or more packets includes a resilient bit in a header portion, the resilient bit designating a bit status, the bit status allowing each of the plurality of nodes to determine whether the one or more packets travel on the secondary connection in order to reduce the bandwidth of the secondary connection.
